(19) United States
(12) Patent Application Publication
(10) Pub. No.: US 2021/0218811 A1
(43) Pub. Date: Jul. 15, 2021

(54) GLOBAL CONTROL SYSTEM FOR CONSUMPTION OF ENERGY RESOURCES ON THE BASIS OF IOT TECHNOLOGY

(71) Applicant: INSYTE-MANAGEMENT LTD, Perm (RU)

(72) Inventors: Aleksei Vladimirovich Kychkin, Perm (RU); Sergey Viktorovich Gribanov, Perm (RU)

(21) Appl. No.: 15/734,011

(22) PCT Filed: Jul. 4, 2019
(86) PCT No.: PCT/RU2019/050104

§ 371 Date: Dec. 1, 2020

(30) Foreign Application Priority Data
Jul. 5, 2018 (RU) 2018124697

(51) Int. Cl. H04L 29/08; G06F 16/182; G06F 16/27; H04L 12/803

(52) U.S. Cl. CPC H04L 67/12; G06F 16/182; G16Y 20/30; H04L 47/125; G06F 16/27

(57) ABSTRACT

A system for global IoT-based management of energy resources consumption comprises at least two identical hardware and software data processing and IoT control complexes having a web server and an application server connected to the web server and comprising a unit for gathering and transferring data over I-things protocols, an analytical unit and a control unit configured to control I-things; a data storage connected to the application server of each of the at least two hardware and software data processing complexes via the bus. The system further comprises: a file server connected to the application server of each of the at least two data processing complexes via the bus and configured to exchange information with clients via Internet; a load balancing unit configured to exchange information with I-things via Internet and connected to each of the at least two data processing complexes via the web server of respective hardware and software complex; and a message queue control unit configured to exchange information with clients via Internet and connected to the at least one data processing complex via the web server of respective complex.

### FIELD OF ART

The invention relates to data processing systems intended for management, particularly, global integrated IoT-based management of energy resources, as a universal upper level of a set of independent multi-level engineering systems of buildings and structures, industrial facilities, urban infrastructure objects, transport units, and more specifically to a system for global IoT-based management of energy resources consumption.

Hereinafter, the description and claims use the following terms:

“IoT”—Internet of Things,

“I-thing”—Internet-enabled thing,

“energy data”—numerical values defining quantity and quality metrics of consumption, production, transportation and storage of various types of energy resources,

“IoT-based management”—IoT-based management of energy resources, management of energy resources consumption using Internet of Things technologies.

### BACKGROUND OF THE INVENTION

Automated Information and Measurement System (RU 83829 U1, IPC: F24D1/00, published Jun. 20, 2009) is known in the art, which is used to control energy resources consumption and regulate temperature of consumed water. The system comprises a multifunctional, three-level hierarchical structure consisting of metering, communicating and computing components that form measurement channels. The first level consists of primary metering components that take measurements of parameters of heat carrier, electricity, continuously or discretely, at a required time interval. The second level of the system uses measurement transducers designed to receive the measurement information from the primary metering components and transmit the data further via wireless radio channels, industrial network communication networks and Ethernet networks, archive and transmit the data on request to the server and operator workstations. The third (upper) level of the system comprises a server and/or an operator's automated workstation capable to function as an archive database server based on a computer with dedicated software. The third level of the prior art system acts as a local system for management of energy resources consumption.

The disadvantage of this automated information and measurement system is that it has a single server, which is not a web server; therefore, it cannot provide management of energy consumption simultaneously for a plurality of I-things located in any Internet covered areas in the world.

Another known Information and Analytical Energy Resource Accounting System is used to gather data through radio communication and subsequently analyze the acquired information to construct information and analytical systems for accounting the consumption of energy resources: cold and hot water, natural gas, thermal energy, electricity and other (RU 2453913 C1, IPC G06F17/00, published Jun. 20, 2012). The system has three levels: the lower level comprises control sensors and meters of fuel and energy resources (hereinafter FER) installed at the customer's object; the middle level comprises communication stations and automation cabinets providing communication with the control sensors and meters of fuel and energy resources consumption, and the upper (third) level comprises a central server with database software, web-interface, and analytical data processing tools.

The energy resources accounting system comprises FER consumption meters, communication stations, automation cabinets, and a central server. The communication station comprises a GSM-controller combining a local data collection and transmission controller and a GSM-modem on a single hardware platform. The GSM controller collects data simultaneously from control sensors and TER consumption meters regardless of interface settings and protocol features and establishes GPRS connection. The communication station can simultaneously send requests received from the central server and transmit responses to it via several communication links from the automation cabinets. Remote workstation computers are connected to the central server.

The disadvantage of this energy resources accounting system is that it comprises a single web server, therefore, it is not able to process great amounts of data, and does not provide management of energy consumption simultaneously for a plurality of I-things located in any Internet covered areas in the world.

### SUMMARY OF THE INVENTION

The object of the invention is to provide a system for global IoT-based management of energy resources consumption, which ensures management of energy resources consumption simultaneously for many I-things located in any Internet covered areas in the world.

The technical result achieved by the present invention provides: it expands functionality of the system, optimizes energy resources management through enabling remote information interaction with I-things located anywhere in the world, increases the amount of information processed, improves the reliability of processing data packets from I-things and clients.

The above technical result is attained by providing a system for global IoT-based management of energy resources consumption, the system comprising:

at least two identical hardware and software data processing and IoT control complexes, each of the complexes having a web server and an application server connected to the web server, the application server comprising:

a unit for gathering and transferring data over I-things protocols, an analytical unit and a control unit, the control unit configured to control I-things, and a bus for connecting the units with each other;

a data storage comprising a measurement database and an attribute database, the data storage configured to scale internal data storage segments and connected to the application server of each of the at least two hardware and software data processing complexes via the bus;

a file server connected to the application server of each of the at least two hardware and software data processing complexes via the bus and configured to connect to the Internet to exchange information with clients;

a load balancing unit configured to connect to the Internet to exchange information with I-things and connected to each of the at least two data processing complexes via the web server of respective hardware and software complex; and

a message queue control unit configured to connect to the Internet to exchange information with clients and connected to the at least one hardware and software data processing complex via the web server of respective hardware and software complex;

wherein the message queue control unit is further connected to the load balancing unit to form and subsequently process the queue of messages.

To attain the object, the present invention uses IoT-based management of energy resources consumption and a plurality of identical IoT-based hardware and software energy data processing and control systems with even load distribution between them, for this purpose a load balancing unit is used, the unit configured to form queues of data packets and control commands, and to exchange of information with I-things using the control unit of the application server of each hardware and software complex that is configured to implement I-things control scenarios.

The invention enables global management of energy resources consumption of a plurality of dependent or independent objects located anywhere in the world, using a single global IoT-based management system.

Management of consumption of energy resources by objects is a process which is implemented at the energy consumer objects by directly changing the operating mode of equipment and devices (I-things), specifying the automatic control scenario, i.e. certain rules for operation of the equipment and devices in accordance with settings, including processing the events and time, remote control, so as to effect absolute and relative (specific) metrics of energy consumption per unit of time. Absolute energy consumption value is determined quantitatively using metering devices. Relative (specific) value is determined as the ratio of the amount of consumed energy or resource to the volume of useful work or product produced. For example, if an object has several devices, each operating in a certain mode and consuming a fixed amount of energy per unit of time, then the total energy consumption of this object can be assumed to be fixed, determined by a single value and corresponding to a first mode. If the operating mode of the devices changes, consumption of the entire object changes, which will correspond to a second mode. Taking into account a large number of state variables and mode combinations for objects, absolute and relative values of energy consumption per unit of time for a single object can vary greatly depending on operating modes of the equipment and devices—components of the object. In this case, the energy resources management is essentially to generate and implement a control algorithm for equipment and devices of objects, minimizing absolute and relative metrics of energy consumption.

The technical result of the invention also consists in expanding the stock of energy resources management means by the use of global monitoring of quantity and quality of electrical energy (Energy Quality is a set of characteristics of electrical energy in terms of frequency and voltage, computed as IEEE 1159-1995 indicators, IEC 61000-4-30), monitoring the consumption of heat energy, technical and drinking water, steam, gas, fuel oil, complex system planning (according to ISO50001 International Standard) of energy consumption with subsequent IoT-based management of energy resources in predictive analytics modes. Predictive analytics mode implements the following sequence of steps: at the first step, a predictive model is trained on measurements of energy consumption parameters and other parameters, e.g. environmental characteristics, for several months. Further, the forecast error is calculated based on a test sample. The predictive analytics modes are implemented by an analytical unit. The analytical unit calculates short and long-term forecasts of energy consumption and other parameters of objects, and forecasts of environment parameters and customer actions. Control unit uses the prediction results in scenarios in the same way as it uses measurement results in the scenarios.

If the error is large (more than 10%), the model is adjusted and trained. A linear neural network or a number of nonlinear regression models, is used as a basic model. Taking into account the predicted values of changes in energy consumption and environment parameters at a given instant, a control command is generated and transmitted to I-things.

### BRIEF DESCRIPTION OF THE DRAWING

The invention is further illustrated by the description of a preferred embodiment with reference to the accompanying drawing, in which:

FIG. 1 is a functional diagram of a system for global IoT-based management of energy resources, comprising three hardware and software data processing complexes according to the invention.

### DESCRIPTION OF PREFERRED EMBODIMENT

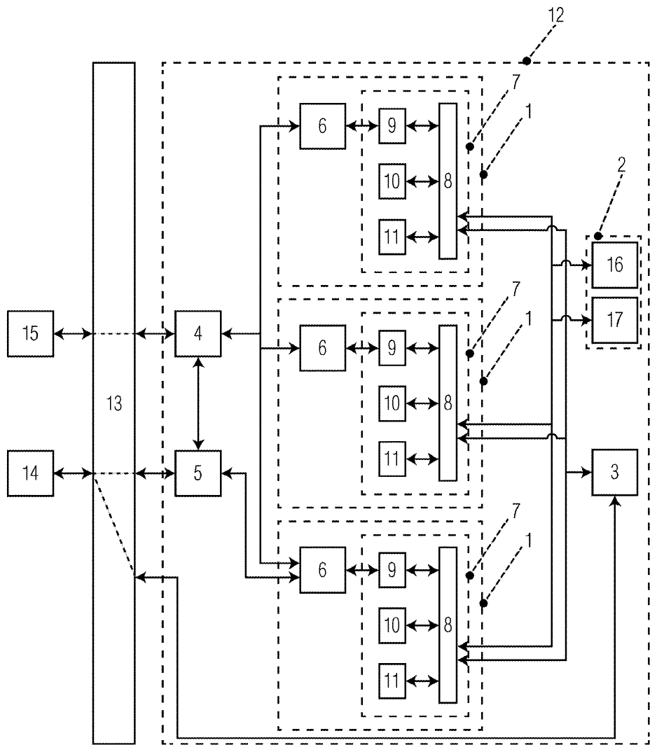

A system 12 for global IoT-based management of energy resources consumption comprises at least two identical IoT-based data processing and control hardware and software complexes 1, each containing a web server 6 and an application server 7 (FIG. 1). FIG. 1 shows an exemplary system comprising three IoT-based data processing and control hardware and software complexes 1.

The number of hardware and software complexes 1 in the system 12 is determined by the computing power required to provide energy consumption management for a specified number of I-things, which allows increasing the amount of data processed by the system and preventing the loss of data packets.

The application server 7 comprises a unit 9 for gathering and transferring data over I-things protocols, an analytical unit 10 and a control unit 11 configured to control I-things, and a bus 8 for connecting units 9, 10, 11 with each other.

The system 12 comprises a data storage 2, common for the entire set of complexes 1 included in the system 12. Data storage 2 contains two databases, particularly, a measurement database 16 and an attribute database 17, and is common for all data processing complexes 1. The storage 2 is adapted to scale internal data storage segments and connected to the application server 7 of each of the at least two data processing hardware and software complexes 1 via the bus 8.

The measurement database 16 stores data received from I-things, such as measurement data, results of analysis, forecasts, plans, and norms. It is a high-speed database that can be cluster-based.

The attribute database 17 stores all information about clients, information about controlled objects, information about I-things as control devices, their identifiers, nominal values of measured parameters, attribute data of equipment, reference books.

The system 12 also comprises a file server 3, which stores data in the form of files, including settings of programs and operating modes of the system, mathematical scripts with calculation programs, reports on calculation results. The file server 3 is a dedicated server for file I/O operations, which stores files of any type and has a large disk space capacity. In the this embodiment, the file server 3 is connected to the application server 7 of each of the three hardware and software data processing complexes 1 via the bus 8 and is adapted to connect to the Internet 13 to exchange information with clients 14.

The file server 3 is adapted to send mathematical scripts (programs with calculations commands) to the analytical unit 10, receive calculation results from the analytical unit 10 and save them as a report file; and stores settings of the programs used by the control unit 11 in its operation. The file server 3 is also configured to store data coming directly from clients via the Internet over the File Transfer Protocol (FTP).

Web-servers 6 transfer information over standard Internet protocols from I-things 15 and clients 14 to the system 12 for global IoT-based management of energy resources consumption.

Each application server 7 contains application packages for mathematical processing of information, which use mathematical scripts with calculation programs stored in the analytical unit 10 and/or stored on the file server (statistics and other calculations), logic, software packages for neural network analysis of energy consumption data, all scenarios for managing the systems, including scenarios for managing typical facilities, such as boiler equipment, lighting, circulating water pumps, ventilation and air conditioning systems, calculations of base energy line (baseline consumption), specific energy consumption metrics, cost, failure analytics, factor analysis, energy consumption plans, planned and actual rates, forecasts.

Units 9, 10 and 11 of each server 7 are connected through the bus 8 to each other, to the data storage 2 and to the file server 3 for receiving and transmitting information.

The bus 8 of the application server 7 can connect additional conversion units, and communication, encryption and data protection protocols. To connect additional units to the bus 8, a general bus access algorithm is provided.

Unit 9 for gathering and transferring data over Internet protocols, both from I-things 15 and clients 14, is designed to gather and map data, send control commands in various protocol formats supported in the system.

The analytical unit 10 is configured to process and analyze metrics of energy consumption. The analytical unit 10 is connected to the storage 2, file server 3, unit 9 and 11 via the bus 8.

The control unit 11 is configured to execute I-things control scenarios using control commands to on/off power, change output signal level, application start logic, determine I-things polling periods, interact with the storage 2; in particular, it receives measured data from measurement database 16, while information about control objects, information about I-things as controlled devices, their identifiers, nominal values of measured parameters, attribute data on equipment, directories is received from the attribute database 17. The unit 11 generates control commands for I-things 15 according to control scenarios. Control scenarios that decrease absolute and relative metrics of energy consumption will implement energy-saving operation modes of I-things and client objects.

Scenario consists of a sequence of IF-THEN rules. The sequence of rules in the scenario is determined by the equipment operation logic aimed at minimizing the downtime, idling, losses, as well as preventing accidents and leaks. The rules are determined by the client either independently or with the assistance of experts in energy audit and management, and energy conservation.

The system 12 also comprises a load balancing unit 4 configured to connect to the Internet 13 to exchange information with I-things 15 and connected in the described embodiment to each of the three data processing complexes 1 through the web server 6 of respective hardware and software complex 1.

The load balancing unit 4 is intended for information exchange between complexes 1 and I-things 15. The load balancing unit 4 is connected to all web servers 6 of complexes 1 and, via the Internet 13, with a plurality of I-things 15. The unit 4 interacts only with I-things 15 and does not interact with clients 14.

The load balancing unit 4 is needed to timely process all data packets from I-things since it can send part of the data to any web server 6, if any complex 1 including respective web server 6 is not fully loaded. Functions of the unit 4 include: receiving data packets from I-things, ensuring uniform loading of hardware and software complexes 1, sending control packets to I-things 15.

The system 12 also comprises a message queue control unit 5, which is configured to connect to the Internet 13 for exchanging information with clients 14 and is connected to at least one hardware and software complex 1 via a web server 6 of the respective hardware and software complex 1.

Furthermore, the message queue control unit 5 is also connected to the load balancing unit 4 for forming and subsequently processing the queue of messages.

The message queue control unit 5 operates with I-things 15 over the IoT protocol using the unit 4, provides temporary storage of data packets from I-things using the queue of messages.

In normal mode, i.e. when there is no overload on the hardware and software complexes 1, the unit 5 operates only with clients 14. However, when data packets arriving from I-things 15 to the unit 4 cannot be distributed to any of the hardware and software complexes 1 due to full load on all the hardware and software complexes 1, unprocessed data packets from I-things are transferred from the unit 4 to the unit 5 for queuing. The queue is common for messages from clients 14 and from I-things 15. After unloading any hardware and software complex 1, messages received from I-things are transferred from the queue in the unit 5 back to the unit 4 and therefrom to the relieved hardware and software complex 1 for processing.

However, messages from clients 14 arriving at the unit 5 are transferred only to the hardware and software complex 1 connected to the unit 5 directly, without participation of the unit 4, regardless of whether these messages were processed immediately or were queued. Where the unit 5 is overloaded, messages from clients 14 are added to the queue and processed after unloading the respective hardware and software complex 1, according to the rules set for processing the queue.

Data packets from I-things 15 can arrive at the unit 4 either continuously, at a user-specified interval, or in asynchronous mode, when certain conditions are achieved, so the queue is efficient here. The user is an expert in energy auditing and management, in energy saving, who configures the system 12.

Since the units 4 and 5 are connected to each other, if a data packet from I-things 15 is in the queue for a long time, i.e. the waiting time for message processing has exceeded the permissible time specified by the user, while there are complexes 1 with a low load, the unit 4 will automatically connect the least loaded complex 1 to operation and the data packet from the queue of the unit 5 will be transferred through the unit 4 to respective web server 6 of the least loaded complex 1.

Client 14 is a person who concluded a contract with the owner of the system 12 for provision of paid services for IoT-based management of energy resources consumption. Services of energy consumption management include direct manual change of operating mode of equipment and devices at the client's facility, setting automatic control scenarios; meanwhile, the client can be geographically in any place in the world provided it is Internet-enabled.

Client 14 can set or change the rules within the scenario of managing his I-things 15 connected to the system 12. In line with these rules, the control unit 11 generates control commands for the I-things 15. For example, client 14 sends via the Internet 13 to the web server 6 through the unit 5 a message containing a new sequence of rules within the scenario. Then, using the graphical interface of the web server 6, client 14 sends a message to the unit 11, which in turn generates a control command for the I-thing 15. Client 14 can set control scenarios, receive reports, edit mathematical scripts with calculation programs stored on the file server 3 to add new Or correct existing calculations for implementing management of energy resources consumption.

I-thing 15 takes measurements of parameters and executes commands for controlling operating modes of the energy consumption object, received from the unit 11 of the hardware and software complex 1. I-thing 15 supports Internet protocols and is configured to operate with the system 12.

I-thing 15 comprises a sensor and/or an actuator, and an IoT controller capable to interact with the Internet over standard protocols, and via the Internet with the outside world over dedicated IoT protocols. To provide remote control of the I-thing 15, the unit 11 sends generated control command to the IoT controller of the I-thing, which transfers the received command to the actuators of the I-thing 15.

Example 1 of IoT controller of I-thing. The simplest IoT controller in this set is an energy consumption recorder, which takes quantity and quality measurements of electrical energy and controls the actuators using relays.

The IoT controller receives information from sensors taking measurements of instantaneous and average currents in phases, voltages, active, reactive and apparent power, energy, frequency, harmonics, current unbalance, nonsinusoidality and other parameters defining the amount and quality of electrical energy consumed by the object; processes and transfers signals for processing to the analytical unit 10 and the control unit 11 of the hardware and software complex 1 through the unit 4. Then, the controller receives feedback from the unit 11 in the form of a control command, and transfers the command to the actuators of the I-thing 15.

Example 2 of IoT controller of I-thing. Lighting is controlled by a dimmer, which can control the lighting load up to 2 kilowatts in response to control signal from the control unit 11.

Example 3 of IoT controller of I-thing. To measure physical signals a climate module can be used, which switches on temperature, humidity, and pressure sensors using standard unified signals (4-20 mA, 0-10 V),

Table below shows, as an example, a typical set of I-items.

The system for global IoT-based management of energy resources consumption operates in the following manner.

Data packet from an I-thing 15 first enters the load-balancing unit 4 having a fixed network address.

Respective program of the load-balancing unit 4 determines the load on each hardware and software complex 1 and sends the data packet to the least loaded hardware and software complex 1 via the web server 6 of the complex 1. By so doing, the unit 4 distributes the load evenly between the hardware and software complexes 1 owing to feedback from web servers 6 to the unit 4, thereby increasing the amount of information processed and providing the achievement of technical effect.

When the unit 4 determines the overload on all complexes 1, it sends data packets received from I-things to the message queue control unit 5 for temporary storage. All incoming data packets from clients 14 are sent to the unit 5, where, if necessary, they are also temporarily stored in a queue mode.

The storage 2 receives data packets from the server 7 via the bus 8. However, packets that did not reach the unit 7 due to the maximum load on the hardware and software complex 1 are temporarily stored in the unit 5 in a queue mode until they can be transferred to a software hardware complex 1, and then they are saved in the storage 2.

The message queue control unit 5 functions as follows. The queue control unit 5 estimates whether the hardware and software complex 1 is ready for data processing. If any of the complexes 1 is relieved, the unit 5 takes the first data packet in the queue from its memory and, if this data packet is from an I-thing 15, sends the packet to the unit 4, which further sends the data packet to web server 6 of the unloaded complex 1.

If a data packet comes from client 14, the unit 5 transfers it to the web server 6 of the complex 1, which is directly connected to the unit 5. All remaining data packets are shifted forward in the queue. When the queue of messages from I-things comes up, they are moved from the queue to the unit 4 and redistributed among the least loaded hardware and software complexes 1, and when the queue of messages from client 14 comes up, they are moved to the web server 6 of the hardware and software complex 1 directly connected to the unit 5. If the load on all the hardware and software complexes 1 is normal, i.e. messages from the I-things have time to be processed without creating a queue, and no queue is formed at the unit 5, messages from clients 14 arriving at the unit 5 are immediately sent to the web server 6 of the hardware and software complex 1 connected to the unit 5.

Communication between the unit 4 and the unit 5 enables forming a common queue of data packets coming to the unit 4 from I-things and to the unit 5 from clients, which are not processed immediately, thereby allowing to avoid the loss of data packets during periods of maximum load on the hardware and software systems 1, and processing the queue in accordance with the above principles of redirection between the units 4 and 5 provides even distribution of the load between free hardware and software complexes 1, thereby increasing the number of processed data packets.

If a new data packet from an I-thing 15 arrives at the instant when all complexes 1 are busy, or a new data packet from client 14 arrives at the instant when the complex 1, directly connected to the unit 5, is busy, the data packet is placed into RAM of the unit 5, subsequently after the last in queue. Upon reducing the load on any one of the complexes 1, data packets from I-things 15 are transferred from the queue of the unit 5 to the unit 4, which then transfers them to the unloaded complex 1. Upon reducing the load on the complex 1 directly connected to the unit 5, data packets from clients 14 are transferred from the queue of the unit 5 to the web server 6 of this complex 1.

Queue of data packets from I-things 15 and from clients 14 is common and ensures reliable processing of requests, allows the loss of unprocessed data packets from I-things to be avoided owing to the temporary storage of information messages put in the queue, implemented in the unit 5, until they can be transferred to any one of hardware and software complexes 1. The number of data packets in the queue is varied automatically by the load balancing unit 4 so that the time the data packet is in the queue does not exceed a predetermined time threshold.

Therefore, the provision of the load balancing unit 4 in the system 12 ensures the achievement of technical effect such as increasing the amount of information processed, and the provision of the message queue control unit 5 ensures the achievement of technical effect such as increasing the reliability of processing data packets from I-things and clients.

The unit 4 provides even distribution of messages from the things among unloading hardware and software complexes thereby minimizing the downtime of free hardware and software complexes 1. The unit 5 enables saving all incoming data packets until it becomes possible to process them by the hardware and software complex 1 (until the hardware and software complex is unloaded), preventing the loss of data packets that are not processed timely. This means that all received messages will be saved and processed with time.

The file server 3 is involved in the operation of units 10 and 11. The file server 3 is configured to send mathematical scripts (programs with calculation commands) to the unit 10, receive calculation results from the unit and save them as a report file, and stores program settings used by the unit 11 in its work. The file server 3 is also configured to store data received directly from clients via the Internet 13 using the file transfer protocol (FTP).

Having received a data packet from the unit 4 or unit 5, the web server 6 transfers it to the unit 9 for gathering and transmitting information.

The unit 9 transfers data packets via the bus 8 to the data storage 2 and at the same time transfers them to the unit 10 for mathematical processing and to the control unit 11 to generate a control command.

The unit 10 executes mathematical processing of data packets using calculation programs integrated in this unit, and programs that are stored on the file server 3. Calculation results of the unit 10 are transmitted via the bus 8 to the control unit 11 and the storage 2, and can also be transferred in the form of reports to the file server 3. The control unit 11 processes data packets received via the bus 8 from the units 9 and 10, and generates a control command in accordance with control scenarios. When generating control commands, the unit 11 refers to reference tables in the storage 2 to acquire information about control objects, information about I-things as devices to be controlled, nominal values of measured parameters, and attribute data on equipment.

Feedback of the system 12 with the I-thing 15 is performed as follows. Generated control command is transferred over the bus 8 to the unit 9, and then to the web server 6, the unit 4 and via the Internet 13 is transmitted to the I-thing 15, the operating mode of which is varied in response to the control command, i.e. remote control of energy consumption is implemented.

Having generated a control command in accordance with control scenarios, the control unit 11 sends it through the bus 8, the unit 9, the web server 6, the unit 4 to the I-thing 15, which changes the operating mode by executing the received command.

Client 14 can remotely control own I-things connected to the system 12. The control provides the ability to client 14 to set or change independently, through the Internet 13, the rules within the control scenario of own I-things 15 connected to the system 12. In accordance with these rules, the control unit 11 generates control commands for the I-things 15. To execute control, client 14 sends via the Internet 13 a message to the web server 6 through the unit 5. Then, using the graphical interface of the web server 6, the client sends a message to the control unit 11, which generates a control command for the I-thing, sends it through the bus 8 to the unit 9, then to the web server 6, the unit 4 and to the I-thing 15.

Feedback from client 14 is performed through the graphical interface of the web server 6, connected directly to the unit 5. The interface displays information about the state of I-things 15, operating modes of objects, and energy consumption of objects.

Energy consumption can be reduced by coordinated control of I-things 15 according to scenarios minimizing equipment downtime and idle, losses of energy resources, preventing emergencies, etc.

Therefore, the control unit 11 of the system 12 ensures the achievement of technical effect such as expansion of functionality of the system and optimization of management of energy consumption owing to the ability of remote information interaction with I-things.

The client can create, edit and delete rules, both in the conditional part and in the action part. To do this, client 14 sends via the Internet 13 a message to the web server 6 through the unit 5. Then, using the graphical interface of the web server 6, the client performs necessary actions on the rules, and results of changes in the rules are saved in the unit 11.

Operation of I-things in accordance with scenarios leads to variation in the energy consumption of the object and achievement of technical effect of the present invention, i.e. optimization of energy consumption management owing to the ability of remote control of I-things via the Internet.

TABLE

| | Type of IoT | Number of | | | |
|---|---|---|---|---|---|
| No. | controller | channels | Inputs | Outputs | Notes |
| 1 | Single channel | 1 | U:L,.₃,N | 1 DO | For each channel: |
| | three-phase | | I:CT,₃ | | analog input for |
| | recorder | | | | measuring voltage between |
| 2 | Four channel | 4 | 4U:L1.₃,N | 4 DO | each phase (L) and |
| | three-phase | | 4I:CT,₃ | | neutral (N); |
| | recorder | | | | analog input for |
| 3 | Single channel | 1 | 4U:L,N | 4 DO | measuring current (using |
| | single-phase | | 4I:CT | | current transformer, CT) |
| | recorder | | | | for each phase; |
| 4 | Four channel | 4 | 4U:L,N | 4 DO | one discrete output |
| | single-phase | | 4I:CT | | based on a solid-state relay. |
| | recorder | | | | Measurements: effective |
| 5 | Eight channel | 8 | 8U:L,N | 8 DO | values of current and |
| | single-phase | | 8I:CT | | voltage; full, active and |
| | recorder | | | | reactive power; power |
| | | | | | factor; total energy; |
| | | | | | network frequency; |
| | | | | | harmonic coefficient; |
| | | | | | current distortion |
| | | | | | factor; current unbalance |
| 6 | Single channel | 1 | 2 AI | 1 AO | For each channel: |
| | dimmer | | | | two analog inputs (0- |
| 7 | Four channel | 4 | 8 AI | 4 AO | 10 b/0-20 MA/4-20 MA); |
| | dimmer | | | | one output for load |
| 8 | Eight channel | 8 | 16 AI | 8 AO | control from 0 to 2 kW; |
| | dimmer | | | | Measurements: effective |
| | | | | | values of current and |
| | | | | | voltage; full, active |
| | | | | | and reactive power; |
| | | | | | total energy |
| 9 | Single channel | 1 | 2 DI | 1 DO | For each channel: |
| | relay module | | | | two discrete inputs |
| 10 | Four channel | 4 | 8 DI | 4 DO | (12-24 V); |
| | relay module | | | | one output for |
| 11 | Eight channel | 8 | 16 DI | 8 DO | controlling a load up |
| | relay module | | | | to 2 kW, based on |
| | | | | | solid-state relay |
| | | | | | Measurements: effective |
| | | | | | values of current and |
| | | | | | voltage; total, active |
| | | | | | and reactive power; |
| | | | | | total energy |
| 12 | IR transceiver | 1 | 1 IR | 4 DO | IR transceiver (angle of |
| | | | | | command transmission |
| | | | | | vertically/horizontally - |
| | | | | | 90°) |
| | | | | | four discrete outputs |
| | | | | | based on solid state |
| | | | | | relay |
| 13 | Single channel | 1 | 1 AI | 1 AO | For each channel: |
| | universal | | 2 DI | 2 DO | one analog input (0-1 |
| | controller | | | | Ov/0-20 mA/4-20 mA); |
| 14 | Four channel | 4 | 4 AI | 4 AO | two discrete inputs |
| | universal | | 8 DI | 8 DO | (12-24 V) with counting |
| | controller | | | | mode; |
| 15 | Eight channel | 8 | 8 AI | 8 AO | one analog output (0-1 |
| | universal | | 16 DI | 16 DO | Ov/0-20 mA/4-20 mA); |
| | controller | | | | two outputs for load |
| | | | | | control up to 2 kW, |
| | | | | | based on solid-state |
| | | | | | relay |
| 16 | Climatic module | 1 | 4 AI | | Measurements: |
| | | | | | temperature, humidity, |
| | | | | | illumination, carbon |
| | | | | | monoxide |
| 17 | Modbus RTU | 1 | RS-485 | RS-485 | Modbus Master/slave |
| | Gateway/IoT | | Ethernet | Ethernet | switching can be provided |
| | | | Wi-Fi | Wi-Fi | |
| 18 | Pulse counting | 8 | 8 DI | | Minimum signal duration |
| | module | | | | 100 μs |
| | | | | | Maximum measured |
| | | | | | frequency at input 5000 |
| | | | | | Hz |
| | | | | | Ranges: 0 . . . 10 Hz; |
| | | | | | 0 . . . 100 Hz; 0 . . . 1000 Hz; |
| | | | | | 0 . . . 5000 Hz |

1. A system for global IoT-based management of energy resources consumption, the system comprising:
at least two identical hardware and software data processing and IoT control complexes, each of the IoT control complexes having a web server and an application server connected to the web server, the application server comprising:
a unit for gathering and transferring data over I-things protocols, an analytical unit and a control unit, the control unit configured to control I-things, and a bus for connecting the units with each other;
a data storage comprising a measurement database and an attribute database, the data storage configured to scale internal data storage segments, and connected to the application server of each of the at least two identical hardware and software data processing and IoT control complexes via the bus;
a file server connected to the application server of each of the at least two identical hardware and software data processing and IoT control complexes via the bus and configured to connect to the Internet to exchange information with clients;
a load balancing unit configured to connect to the Internet to exchange information with I-things and connected to each of the at least two identical hardware and software data processing and IoT control complexes via the web server of a respective hardware and software data processing and IoT control complex; and
a message queue control unit configured to connect to the Internet to exchange information with clients and connected to the at least one hardware and software data processing and IoT control complex via the web server of the respective hardware and software data processing and IoT control complex;
wherein the message queue control unit is further connected to the load-balancing unit to form and subsequently process the queue of messages.
